(19) United States
(12) Patent Application Publication
(10) Pub. No.: US 2002/0155351 A1
(43) Pub. Date: Oct. 24, 2002

(54) Silver encapsulated cathodes for alkaline batteries

(75) Inventor: Stuart Licht, Haifa (IL)

Correspondence Address: BROWDY AND NEIMARK, P.L.L.C., 624 NINTH STREET, NW, SUITE 300, WASHINGTON, DC, 20001-5303, US

(73) Assignee: CHEMERGY, Energy Technologies, Technion City (IL)

(21) Appl. No.: 10/076,410

(22) Filed: Feb. 19, 2002

(30) Foreign Application Priority Data
Feb. 20, 2001 (IL) 141528

(51) Int. Cl. H01M 4/34; H01M 4/50

(52) U.S. Cl. 429/219; 429/224; 429/231.5

(57) ABSTRACT

An electric storage alkaline battery comprising an electrically neutral alkaline ionic conductor, an anode and a cathode, whereby electric storage is accomplished via electrochemical reduction of the cathode and oxidation of the anode, whereby said cathode includes an electrochemically active oxidized silver encapsulated powder.

The present invention relates to electric storage batteries. More particularly, the invention relates to a novel alkaline electric storage battery with a cathode formed from an oxidized silver encapsulated barium manganese or other oxidized silver encapsulated powders.

### BACKGROUND OF THE INVENTION

MnO₂ is the common active cathode material in primary alkaline batteries. As an alternative to MnO₂, a variety of permanganate compounds have been considered for cathode materials due to their high oxidation state which, in principle permits significant storage and release of electrical charge. However, as described by J. Epstein and C. C. Liang, U.S. Pat. No. 3,799,959 (Oct. 12, 1971), most permanganates salts are overly soluble in alkaline solution and this solubility can be destructive to the battery performance. In addition, most permanganate salts do not discharge effectively in the solid phase, although as described by S. Licht and C. Marsh, U.S. Pat. No. 5,549,991 (Aug. 27, 1996), in the solution phase they can support high currents.

Compared to the manganese dioxide alkaline cathode reaction, both manganates and permanganates can have a significantly higher faradaic capacity and higher cathodic potential. The thermodynamic potential for the 1e⁻ permanganate to manganate reduction in aqueous alkaline media is:

MnO₄⁻+1e−→MnO₄²⁻ E=0.56V vs SHE (1)

and manganate also can exhibit a direct discharge to manganese dioxide, summarized as the 2e⁻ reduction:

MnO₄⁻+2H₂O+3e⁻→MnO₂+4OH⁻ E=0.58V vs SHE (2)

and alternately permanganate also can exhibit a direct discharge to manganese dioxide, summarized as the 3e⁻ reduction:

MnO₄²⁻+2H₂O+2e⁻→MnO₂+4OH⁻ E=0.58V vs SHE (3)

In addition, the MnO₂ product can undergo a further 1e− reduction, as utilized in the conventional commercial alkaline (Zn anode/MnO₂ cathode) cell:

2MnO₂+H₂O+2e⁻→Mn₂O₃+2OH⁻ E=0.35V vs SHE (4)

Manganate salts, being in the less oxidized manganese valence state of Mn(VI), will store less charge in principle, than the permanganates. This lower valence state would also suggest that they would be considered to be less chemically active. In principal, as described by equations 2 and 4, permanganate salts can undergo a total of a 4e⁻ alkaline cathodic reduction, and by equations 3 and 4 manganate salts can undergo a total of a 3e⁻ alkaline cathodic reduction. Yet the manganate and permanganate salts have not replaced the widely used commercial alkaline MnO₂ cathode due to a general perception that these salts are too soluble (creating a tendency to react and decompose the anode), and that they exhibit only low stored energy capacity, and/or low current density, charge transfer. Cathodes comprised of these salts would stand to be improved by a means which would increase their discharge capacity, and/or increase their current density and/or decrease their solubility in the alkaline electrolyte used in alkaline batteries.

As with MnO₂, other effective cathode active materials have been recognized and utilized since the 19th century including the oxides of silver, nickel, lead and mercury. In addition, there has been recent interest in alternate high capacity cathode materials including sulfur and polysulfides as described by S. Licht, U.S. Pat. No. 6,207,324 (Mar. 27, 2001), and higher valent iron or “super-iron” compounds as described by S. Licht U.S. Pat. No. 6,033,343 (Mar. 7, 2000). In a like manner other cathodes, including both these established and more recent cathodes, for alkaline batteries stand to be improved by a means which would increase their discharge capacity, and/or increase their current density and/or decrease their solubility in the alkaline electrolyte used in alkaline batteries.

It is an object of the present invention to provide an improvement to cathodes in alkaline batteries which provides a practical storage capacity greater than the theoretical capacity known for these cathode materials. A novel electrochemically active solid cathode is demonstrated using barium manganate. The standard electrochemical potentials for manganate and MnO₂ electrochemical reduction in alkaline solution are well known.

### BRIEF DESCRIPTION OF THE INVENTION

The invention relates to an electrical storage cell, so-called alkaline battery, comprising two half-cells which are in electrochemical contact with one another through an electrically neutral alkaline ionic conductor, wherein one of said half-cells comprises an anode and the other half-cell comprises a cathode, whereby electrical storage is accomplished via electrochemical reduction of the cathode and oxidation of the anode. The cathode contains an electrochemically active oxidized silver encapsulated barium manganate or barium permanganate or other oxidized silver encapsulated powder.

### BRIEF DESCRIPTION OF THE FIGURES:

FIG. 1 is a diagrammatic illustration of the electrochemically active oxidized silver encapsulated powder containing cathode battery according to the invention; and

FIGS. 2 to 6: illustrate graphically performance of various battery aspects according to the invention as described in the Examples.

### DETAILED DESCRIPTION OF THE INVENTION

The novel battery according to the present invention is based on the addition of an electrochemically active oxidized silver encapsulated powder to form a cathode in an alkaline battery.

The encapsulation may be accomplished by any means which coats a powder with an oxidized silver material. In one embodiment the oxidized silver material contains an Ag(I) valent salt, and in a preferred embodiment contains a greater than Ag(I) valent salt, such as an Ag(II) valent salt. In a preferred embodiment the oxidized silver material is introduced as an Ag(II) salt, or as an Ag(I) valent salt which is then raised to a greater than one valence state through contact with an oxidizing agent such as a peroxydisulfate salt or a hypochlorite salt, or by electrochemical oxidation by application of a positive voltage.

Examples of the preferred Ag(II) salt used in the encapsulation include AgO, Ag₂O₂, Ag(OH)₂ or AgF₂. Examples of the Ag(I) salt include Ag₂O or AgOH. Other examples of the Ag(I) and Ag(II) salts include, but are not limited to, silver salts containing any of the following anions: nitrate, nitrite, halide, halate, perhalate, halite, acetate, carbonate, fulimate, lactate, acetylide, levunilate, oxalate, palimate, cyanate, thiocyanate, benzoate, propionate, salicyate, stearate, tartrate, tetraborate, sulfate, thiosulfate, dithionate, selenate, selinide, telluride, tungstate, azide, phosphate, orthophosphate or pyrophosphate. Ag₂O or AgOH. In one embodiment, the oxidized silver salt encapsulation of a powder is accomplished by solvent evaporation of a solution containing a dissolved silver salt, and in a preferred embodiment the powder to be encapsulated is highly insoluble in said solvent. In another embodiment the oxidized silver salt encapsulation of a powder is accomplished by a coating of metallic silver which is then treated with an oxidizing agent, or electrochemically oxidized.

Examples of the preferred powder which to be encapsulated include an oxidized manganese containing compound. Examples of such an oxidized manganese containing compound is an Mn(VI) valent salt including, but not limited to barium manganate, BaMnO₄, potassium manganate, K₂MnO₄, MgMnO₄, CaMnO₄, SrMnO₄, Na₂MnO₄, Li₂MnO₄, Rb₂MnO₄, Cs₂MnO₄, ammonium manganate, or a tetra alkyl ammonium manganate. In another aspect the barium manganate salt, with or without the oxidized silver coating, is added in at least 1 wt % to another cathode active material, such as, but not limited to MnO₂, AgO, Ag₂O, or NiOOH, to improve the capacity, power or cost performance of the other cathode active materials. Other examples of an oxidized silver encapsulated oxidized manganese containing compound is an Mn(VII) valent salt including, but not limited to potassium permanganate, KMnO₄, NaMnO₄, LiMnO₄, RbMnO₄, CsMnO₄, ammonium permanganate, or a tetra alkyl ammonium permanganate. Still other examples of an oxidized manganese containing compound is an Mn(IV) valent salt including, but not limited to manganese dioxide.

Other examples of the powder to be encapsulated include an oxidized nickel containing compound, including, but not limited to, nickel oxide and or nickel oxyhydroxide or a compound containing nickel with clher metals and in various oxidation states. Other examples of the powder to be encapsulated include an oxidized mercury containing compound, or an oxidized lead containing compound, or an oxidized copper containing compound, or an oxidized cobalt containing compound, or an oxidized vanadium containing compound, or a powder that contains zero valent sulfur or contains a polysulfide including zero valent sulfur and reduced sulfur.

Still other examples of the powder to be encapsulated contains a compound which includes iron in a valence state of greater than 3, including but not limited to, BaFeO₄, K₂FeO₄, Na₂FeO₄, Li₂FeO₄, Cs₂FeO₄, Rb₂FeO₄, H₂FeO₄, (NH₄)₂FeO₄, (N(C₄H₉)₄)₂FeO₄, BeFeo₄, MgFeO₄, CaFeO₄, SrFeO₄, La₂(FeO₄)₃, CeFeO₄.2H₂O, Ce₂(FeO₄)₃, Hg₂FeO₄, HgFeO₄, Cu₂FeO₄, CuFeO₄, ZnFeO₄, Ag₂FeO₄, FeO₃, FeFeO₄, Fe₂(FeO₄)₃, CrFeO₄, MnFeO₄, NiFeO₄, CoFeO₄, Al₂(FeO₄)₃, In₂(FeO₄)₃, Ga₂(FeO₄)₃, SnFeO₄, PbFeO₄, Sn(FeO₄)₂, or Pb(FeO₄)₂.

The phrase “theoretical charge capacity” refers to the calculated charge capacity of that cathode material in accord with the known number of faradays (moles electrons) stored per mole of that material. The theoretical charge capacity is calculated through equation 5 and where n is the number of discharge electrons, F is the Faraday's constant=26.801 Amp hour per mol, and Fw is the formula weight:

Theoretical charge capacity=n×F/Fw (5)

For any specified known cathode material, discharged at low current density rate, the phrase “conventional cathode storage capacity” is specifically the theoretical charge capacity of that cathode material. At higher rates of current density, this “conventional cathode storage capacity” is less than the theoretical charge capacity, and refers to the maximum amount of cathode storage capacity previously attainable for the cathode material at this discharge condition. Without being bound to any theory, Table 1 presents the theoretical storage capacity of various cathode materials calculated in accord with equation 5.

TABLE 1
Theoretical charge capacity of several known cathode materials,
determined with equation 2

| cathode | | | Fw | Charge capacity |
|---|---|---|---|---|
| material | cathode name | n | kg/mole | Amp hour/kg |
| BaMnO₄ | barium manganate | 3 | 256.3 | 314 |
| Ba(MnO₄)₂ | barium permanganate | 8 | 375.2 | 571 |
| K₂MnO₄ | potassium manganate | 3 | 197.1 | 408 |
| KMnO₄ | potassium permanganate | 4 | 158.0 | 678 |
| MnO₂ | manganese dioxide | 1 | 86.9 | 308 |
| K₂FeO₄ | potassium super-iron | 3 | 198.0 | 406 |
| BaFeO₄ | barium super-iron | 3 | 257.2 | 313 |
| NiOOH | nickel oxyhydroxide | 1 | 91.7 | 289 |
| Ag₂O | silver oxide | 2 | 231.7 | 231 |
| AgO | silver peroxide | 2 | 123.9 | 433 |
| PbO₂ | lead oxide | 2 | 239.2 | 224 |
| CuCl | copper chloride | 1 | 99.0 | 270 |
| CoO | cobalt oxide | 2 | 74.9 | 716 |
| S | sulfur | 2 | 32.1 | 1672 |
| K₂S₄ | potassium tetrasulfide | 6 | 206.5 | 406 |
| HgO | mercury oxide | 2 | 216.6 | 247 |

The anode of the battery may be selected from the known list of metals capable of being oxidized, typical such as zinc, cadmium, lead, iron, aluminum, lithium, magnesium, calcium; and other metals such as copper, cobalt, nickel, chromium, gallium, titanium, indium, manganese, silver, cadmium, barium, tungsten, molybdenum, sodium, potassium, rubidium and cesium.

The anode may also be of other typical constituents capable of being oxidized, examples include, but are not limited to hydrogen, (including but not limited to metal hydrides), inorganic salts, and organic compounds including aromatic and non-aromatic compounds. The anode may also be of other typical constituents used for lithium-ion anodic storage, examples include, but are not limited to lithium-ion in carbon based materials and metal oxides.

The electrically neutral alkaline ionic conductor utilized in the battery according to the present invention, comprises a medium that can support current density during battery discharge in an alkaline medium. A typical representative ionic conductor is an aqueous solution preferably containing a high concentration of a hydroxide such as KOH. In other typical embodiments, the electrically neutral ionic conductor comprises a high concentration of NaOH.

An electric storage battery according to the invention may be rechargeable by application of a voltage in excess of the voltage as measured without resistive load, of the discharged or partially discharged cell.

According to another embodiment of the invention, means are provided to impede transfer of chemically reactive species, or prevent electric contract between the anode and cathode. Said means includes, but is not limited to a non-conductive separator configured with open channels, a membrane, a ceramic frit, grids or pores or agar solution; such means being so positioned as to separate said half cells from each other.

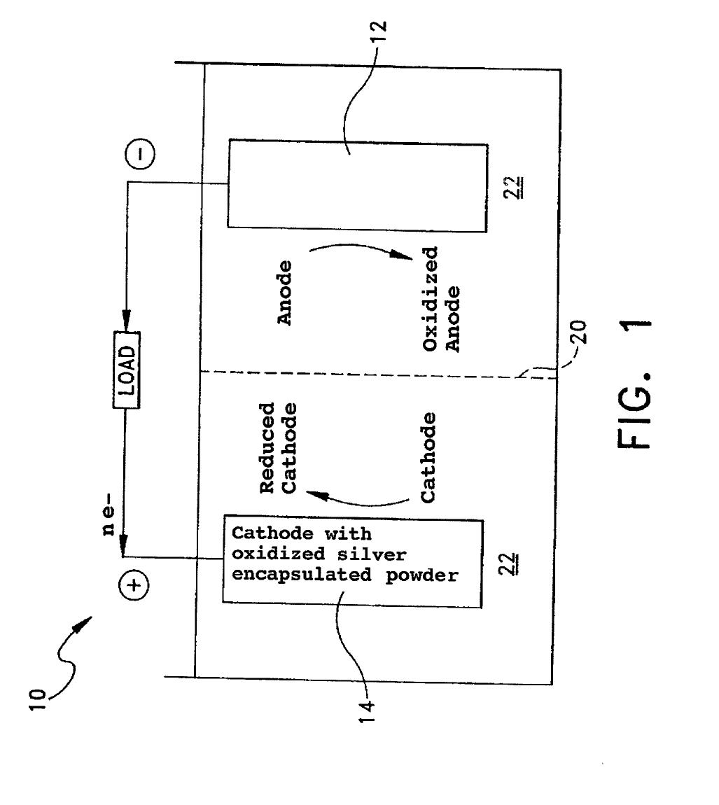

### Detailed Description of FIG. 1

FIG. 1 illustrates schematically an electrochemical cell 10 based on a cathode which contains a barium manganese compound half cell, an electrically neutral alkaline ionic conductor and an anode. The cell contains an electrically neutral alkaline ionic conductor 22, such as a concentrated aqueous solution of KOH, in contact with a cathode which contains an oxidized silver encapsulated powder 14. Reduction of the cathode, is achieved via electrons available from the electrode 14. The anode electrode 12, such as in the form of metal is also in contact with the electrically neutral ionic conductor 22. Electrons are released in the oxidation of the anode. Optionally, the cell may contain a separator 20, for minimizing the non-electrochemical interaction between the cathode and the anode.

The invention will be hereafter illustrated in further detail with reference to the following non-limiting examples, it being understood that the Examples are presented only for a better understanding of the invention without implying any limitation thereof, the invention being covered by the claims. Although the examples used AAA cells, it will be appreciated by those skilled in the art that the increase in performance may be obtained regardless of the cell size. It will be understood by those who practice the invention and by those skilled in the art, that various modifications and improvements may be made to the invention without departing from the spirit of the disclosed concept.

### EXAMPLE 1

This example shows that the simple addition of oxidized silver to cathode powders does not harm their discharge performance, and often can substantially improve the discharge performance. Cells are prepared with identical zinc anodes and separators, as removed from commercial AAA alkaline cells. The cathode mix inserted into the cell 9 wt % graphite and 9 wt % of electrolyte (which is 18 m KOH unless otherwise stated). Cell potential and energy capacity of alkaline super-iron AAA cells were measured during discharge at a constant load rate of either 2.8Ω or 75Ω.

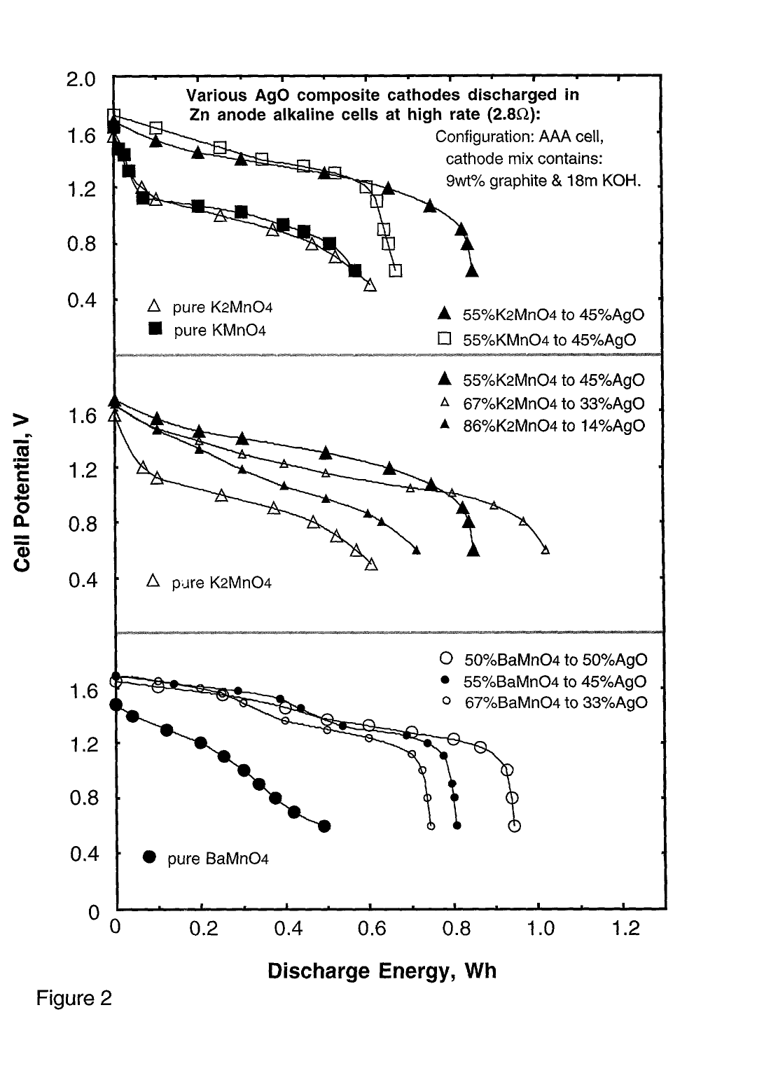

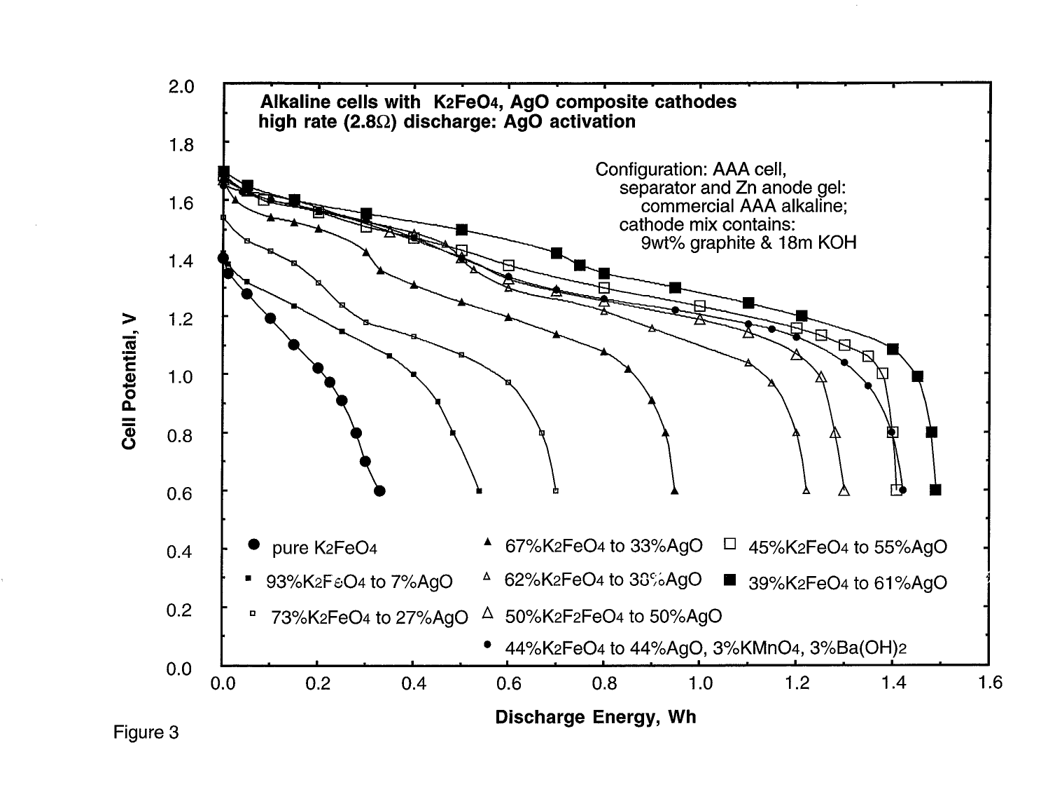

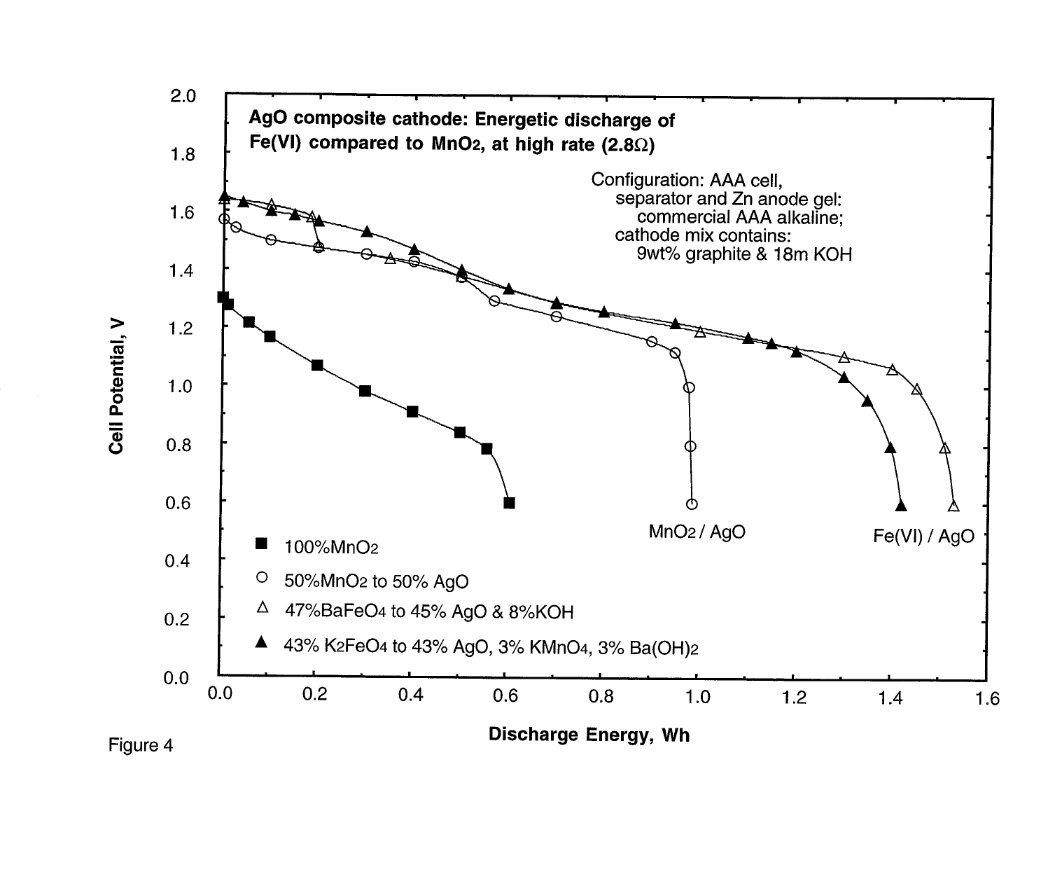

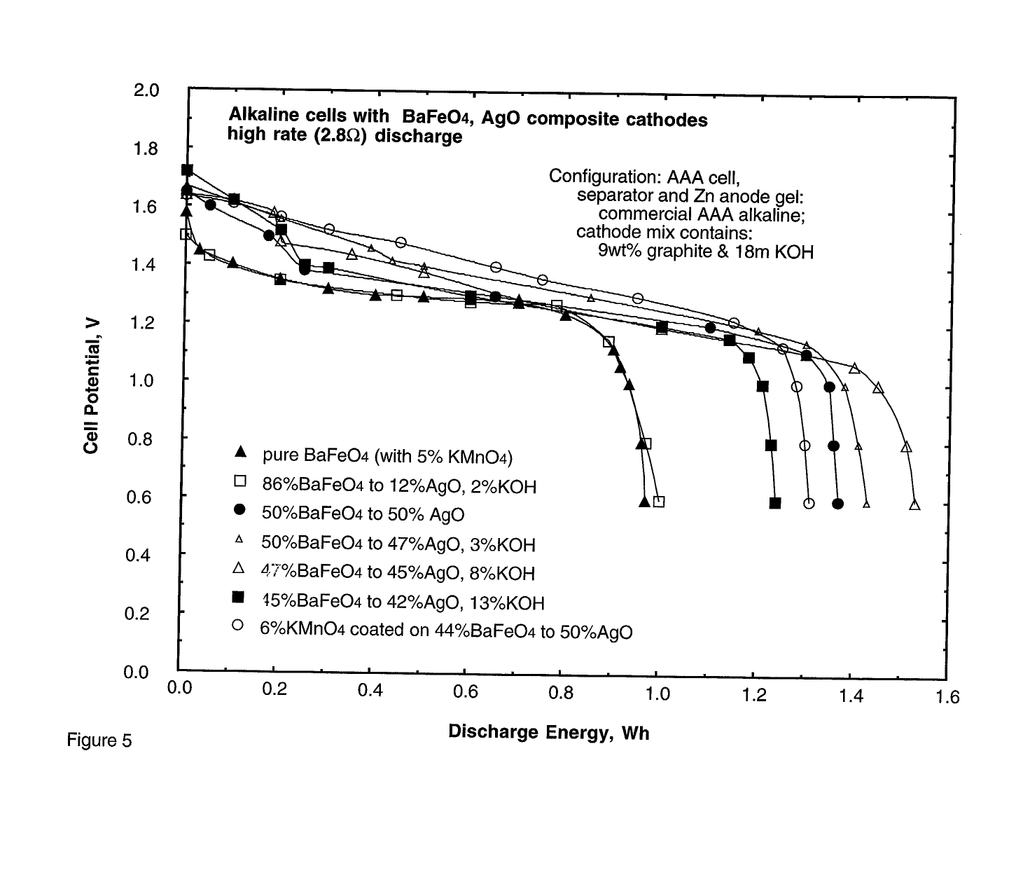

As expressed in Table 1 several materials have a large theoretical cathodic capacity. Whereas several cathode materials such as MnO₂ and BaFeO₄ discharge effectively, and electrochemically release a large fraction of their stored energy, other cathode materials, such as BaMnO₄, KMnO₄, K₂MnO₄ and K₂FeO₄, do not discharge effectively and yield only a low discharge energy. As summarized in Table 2, a large number of various salts added to the ineffective pure BaMnO₄ do not substantially increase the measured discharge capacity, either when discharged quickly (at a high rate over a constant 2.8Ω load) or slowly (at a low rate over a constant 2.8Ω load), and this is again seen in the table for KMnO₄, K₂MnO₄ or K₂FeO₄ with a variety of alternate additives. However, as seen in FIG. 2, and consistent with its high capacity described in Table 1, AgO added in various weight fractions to BaMnO₄, KMnO₄, or K₂MnO₄, substantially increases the measured discharge capacity. This observed increase is even more substantially for AgO added to K₂FeO₄ as shown in FIG. 3. Added AgO can also improve the discharge performance of more effective cathode materials such as MnO₂ or BaFeO₄ as shown in FIGS. 4 and 5.

TABLE 2
Comparison of the discharge behavior in an alkaline AAA cell
of either a K₂FeO₄ cathode, or a KMnO₄ cathode, or a BaMnO₄ cathode
with, or without various solid additives. Relative amounts of the
indicated solid cathode mix are presented. In addition, the final cathode
mix includes 9 wt % graphite and 9 wt % of 18 m KOH. The LiOH salt
cell gave similar results with a saturated LiOH electrolyte.

| Dry Cathode Composition, by mass | | | | Discharge to 0.8 V(constant load) | | | |
|---|---|---|---|---|---|---|---|
| Cathode salt | wt % | salt | wt % | 2.9Ω: E & Vav | | 75Ω: E & Vav | |
| BaMnO₄ | 100% | | | 0.34 Wh | 1.16 V | 0.96 Wh | 1.19 V |
| BaMnO₄ | 90% | KOH | 10% | 0.32 Wh | 1.10 V | 0.98 Wh | 1.18 V |
| BaMnO₄ | 90% | Al₂O₃ | 10% | 0.27 Wh | 1.08 V | 0.78 Wh | 1.19 V |
| BaMnO₄ | 90% | Ba(OH)₂ | 10% | 0.29 Wh | 1.11 V | 0.76 Wh | 1.20 V |
| BaMnO₄ | 90% | Sr(OH)₂ | 10% | 0.28 Wh | 1.09 V | 0.70 Wh | 1.17 V |
| BaMnO₄ | 90% | Ca(OH)₂ | 10% | 0.29 Wh | 1.07 V | 0.73 Wh | 1.18 V |
| BaMnO₄ | 90% | Mg(OH)₂ | 10% | 0.32 Wh | 1.14 V | 0.67 Wh | 1.19 V |
| BaMnO₄ | 90% | LiOH | 10% | 0.27 Wh | 1.08 V | 0.73 Wh | 1.18 V |
| BaMnO₄ | 90% | NaOH | 10% | 0.23 Wh | 1.11 V | 0.75 Wh | 1.20 V |
| BaMnO₄ | 90% | BaTiO₃ | 10% | 0.28 Wh | 1.08 V | 0.93 Wh | 1.16 V |
| BaMnO₄ | 90% | Co₂O₃ | 10% | 0.30 Wh | 1.07 V | 0.77 Wh | 1.17 V |
| BaMnO₄ | 67% | KOH | 33% | 0.22 Wh | 1.10 V | 0.50 Wh | 1.19 V |
| BaMnO₄ | 67% | Al₂O₃ | 33% | 0.25 Wh | 1.06 V | 0.69 Wh | 1.18 V |
| BaMnO₄ | 67% | Ba(OH)₂ | 33% | 0.15 Wh | 1.07 V | 0.49 Wh | 1.14 V |
| K₂MnO₄ | 100% | | | 0.47 Wh | 1.02 V | 1.35 Wh | 1.22 V |
| KMnO₄ | 100% | | | 0.49 Wh | 1.04 V | 0.83 Wh | 1.40 V |
| KMnO₄ | 90% | KOH | 10% | 0.49 Wh | 1.07 V | 1.45 Wh | 1.35 V |
| KMnO₄ | 90% | Al₂O₃ | 10% | 0.48 Wh | 1.09 V | 1.42 Wh | 1.38 V |
| KMnO₄ | 90% | Ba(OH)₂ | 10% | 0.47 Wh | 1.15 V | 1.29 Wh | 1.45 V |
| KMnO₄ | 90% | Sr(OH)₂ | 10% | 0.44 Wh | 1.15 V | 1.43 Wh | 1.39 V |
| KMnO₄ | 90% | Ca(OH)₂ | 10% | 0.34 Wh | 1.17 V | 1.39 Wh | 1.35 V |
| KMnO₄ | 90% | Mg(OH)₂ | 10% | 0.35 Wh | 1.21 V | 1.06 Wh | 1.34 V |
| KMnO₄ | 90% | LiOH | 10% | 0.31 Wh | 1.15 V | 1.34 Wh | 1.24 V |
| KMnO₄ | 90% | NaOH | 10% | 0.27 Wh | 1.17 V | 1.25 Wh | 1.32 V |
| KMnO₄ | 90% | BaTiO₃ | 10% | 0.32 Wh | 1.04 V | 0.91 Wh | 1.45 V |
| KMnO₄ | 67% | KOH | 33% | 0.24 Wh | 1.00 V | 0.90 Wh | 1.23 V |
| KMnO₄ | 67% | Al₂O₃ | 33% | 0.61 Wh | 1.15 V | 1.47 Wh | 1.37 V |
| KMnO₄ | 67% | Ba(OH)₂ | 33% | 0.57 Wh | 1.16 V | 1.40 Wh | 1.37 V |
| KMnO₄ | 67% | Sr(OH)₂ | 33% | 0.55 Wh | 1.14 V | 1.52 Wh | 1.33 V |
| KMnO₄ | 67% | Ca(OH)₂ | 33% | 0.55 Wh | 1.11 V | 1.45 Wh | 1.32 V |
| KMnO₄ | 67% | Mg(OH)₂ | 33% | 0.49 Wh | 1.17 V | 1.47 Wh | 1.31 V |
| KMnO₄ | 67% | LiOH | 33% | 0.03 Wh | 1.25 V | 0.55 Wh | 1.20 V |
| KMnO₄ | 67% | NaOH | 33% | 0.03 Wh | 1.25 V | 0.27 Wh | 1.29 V |
| KMnO₄ | 67% | BaTiO₃ | 33% | 0.34 Wh | 1.16 V | 1.21 Wh | 1.41 V |
| K₂FeO₄ | 100% | | | 0.28 Wh | 1.17 V | 0.68 Wh | 1.36 V |
| K₂FeO₄ | 90% | KOH | 10% | 0.27 Wh | 1.08 V | 0.55 Wh | 1.36 V |
| K₂FeO₄ | 90% | Ba(OH)₂ | 10% | 0.35 Wh | 1.15 V | 0.79 Wh | 1.44 V |
| K₂FeO₄ | 90% | LiOH | 10% | 0.30 Wh | 1.09 V | 0.63 Wh | 1.31 V |
| K₂FeO₄ | 90% | NaOH | 10% | 0.24 Wh | 1.05 V | 0.60 Wh | 1.35 V |
| K₂FeO₄ | 90% | BaTiO₃ | 10% | 0.30 Wh | 1.17 V | 0.58 Wh | 1.45 V |

### EXAMPLE 2

We have found that an oxidized silver coating encapsulating a cathodically active powder can have several advantages compared to the powder when left uncoated. To exemplify the general approach, this example demonstrates one method by which an Ag(I) salt or a Ag(II) salt is used to encapsulated one such material, BaFeO₄. The coating is added as follow: In the silver microencapsulation procedure, BaFeO₄ powder (insoluble in a solvent such as acetonitrile) is added to a soluble solution of silver nitrate (such as dissolved in acetonitrile). 6.9 g AgNO₃ was dissolved by stirring in as little as 7 milliliter liter of acetonitrile (the solution is comprised of AgNO₃ at a concentration of less than or equal to the saturation solubility, which is approximately 1 g of AgNO₃ per 1 ml of acetonitrile). 10.0 g BaFeO₄ powder is added. BaFeO₄ is insoluble in this solution and the suspension was stirred for 5 minutes. The addition of hexane to the suspension decreases the mixture viscosity and improves the coating uniformity. While stirring under vacuum at room temperature, the suspension was dried until becoming solid, and this leaves a coating of a Ag(I) salt over the BaFeO₄. Alternatively, the majority of the solvent can be recovered by filtration, if an alternate low dielectric solvent such as diethyl-ether is added to the acetonitrile slurry. While stirring over a period of 1 hour, it is observed that this salts out an AgNO₃ overlayer onto the BaFeO₄, and maintains the powder as dispersed particles, rather than encrusting, during drying. Less initial mass of AgNO₃ was observed to result in the expected thinner coating, while more AgNO₃ resulted in a thicker AgNO₃ coating. The Ag(I) coating may then be converted, either directly as AgNO₃, or following a hydroxide wash to form Ag₂O.

Conversion of this Ag(I) coating to Ag(II) proceeds as follows: 11.5 g of NaOH was added to 0.15 liter of water with stirring, and maintained at 30° C., 10.0 g of the oxidant K₂S₂O₈ was added while stirring, and followed by addition of the Ag(I) coated BaFeO₄ with stirring continued for 30 minutes. The powder was filtered onto a glass microfiber filter (Whattman GF/A filter paper), and the filtrate discarded. While on the filter paper, the wet powder was washed with 0.5 liter of 0.1 M NaOH, and then rinsed with 1 liter of water. The washed powder was dried overnight under vacuum at room temperature.

ICP (inductively coupled plasma) analysis of the dried powder determined the elements Ag and Fe exist in the powder in the ratios related to the relative initial masses of AgNO₃, converted to AgO, and BaFeO₄. Chemical analysis of the valence state of the iron in the powder is accomplished through redissolution as FeO₄²⁻ to oxidize chromite, and in which the chromate generated is titrated with a standard ferrous ammonium sulfate solution, using a sodium diphenylamine sulfonate indicator:

Cr(OH)₄—+FeO₄²⁻+3H₂O→Fe(OH)₃(H₂O)₃+CrO₄²⁻+OH⁻ (6)

This chromite analysis yields 97% purity as Fe(VI), of the iron within the coated material. The electrochemical capacity of the oxidized silver encapsulated BaFeO₄ is examined by formation of a cathode in an AAA cell configuration as described in Example 1. Discharge of the cell yields results very similar to those described in Example 1 for the cathodes formed from a mixture of BaFeO₄ with AgO.

### EXAMPLE 3

An experiment was carried out, the object being to demonstrate the decreased solubility of an oxidized silver encapsulated powder in potassium hydroxide solutions of concentrations similar to those used in alkaline batteries. Salts which are less soluble are preferred as cathodic materials. As demonstrated in the previous example, an oxidized silver encapsulation does not inhibit effective electrochemical discharge of a BaFeO₄ cathode. This example shows that this coating also acts as an effective membrane diminishing the solubility of the BaFeO₄ in solution typical of alkaline battery electrolytes. Untreated BaFeO₄ powder exhibits a small, but clearly detectable solubility of 0.0015 molar, 0.0017 molar, or 0.0019 molar respectively in 10 molar, 12 molar or 13.5 molar KOH solution, as determined from the magnitude of the observed absorption peak at 505 nm, and without being bound to any theory attributable to the dissolved Fe(VI) species FeO₄²⁻. In these same electrolytes, the oxidized Ag(II) encapsulated BaFeO4 powder, prepared as described in Example 3, exhibits no solubility to within the minimum detectability limits of 0.00008 molar (as measured at this same 505 nm wavelength).

### EXAMPLE 4

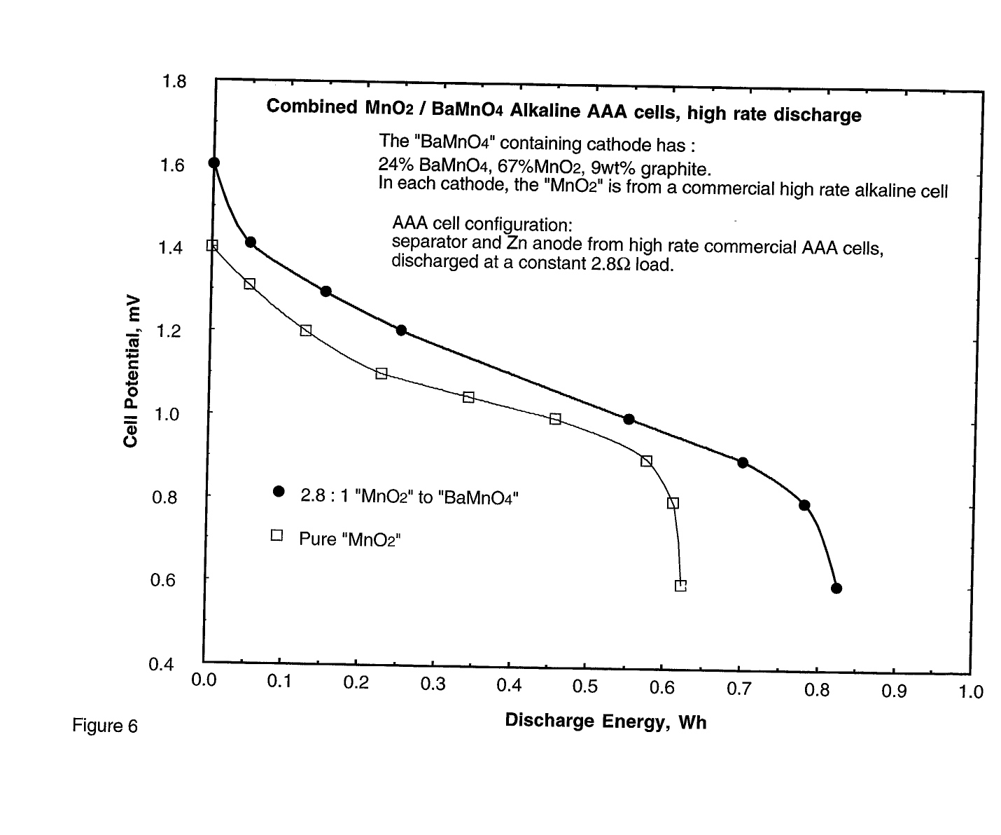

An experiment was carried out, the object being to demonstrate that a synergistic interaction between a poorly discharging cathode material with an effectively discharging cathode material, can result in a measured energy capacity larger than for either of the separate materials alone. In the first example, barium manganate was demonstrated to provide a high energy capacity discharge in the presence of added AgO, but a low capacity discharge in the presence of a variety of added salts. The enhanced activity of BaMnO₄ in the presence of a known effective cathode material such as AgO, will also be seen in combination with another known effective cathode material MnO₂. This example demonstrates that a synergistic interaction results in such a composite electrode, in which the energy capacity measured during discharge can be larger than for the separate effective MnO₂ cathode alone. The electrochemical capacity of cathodes was examined by formation of a cathode in an AAA cell configuration as described in Example 1. FIG. 6, shows a MnO₂ cathode prepared mixed with BaMnO₄, exhibits a higher discharge energy, than that of the MnO₂ cathode alone. A material which can be mixed with the common MnO₂ alkaline cathode, thereby improving the MnO₂ discharge performance, is preferred over the MnO₂ cathode by itself.

1. A battery comprising two half-cells which are in an electrochemical contact with one another through an electrically neutral alkaline ionic conductor, wherein one of said half-cells comprises an anode and the other half-cell comprises a cathode, whereby electrical discharge is accomplished via reduction of the cathode and oxidation of the anode, and whereby said cathode includes an oxidized silver salt encapsulated powder.

2. The battery according to claim 1 whereby said encapsulated powder is an encapsulated oxidized manganese containing compound.

3. The battery according to claim 2 whereby said compound contains a Mn(VI) valent salt.

4. The battery according to claim 3 whereby said Mn(VI) valent salt is barium manganate, BaMnO₄.

5. The battery according to claim 3 whereby said Mn(VI) valent salt is potassium manganate, K₂MnO₄.

6. The battery according to claim 3 whereby said Mn(VI) valent salt is MgMnO₄, CaMnO₄, SrMnO₄, Na₂MnO₄, Li₂MnO₄, Rb₂MnO₄, Cs₂MnO₄, ammonium manganate, or a tetra alkyl ammonium manganate.

7. The battery according to claim 2 whereby said compound contains a Mn(VII) valent salt.

8. The battery according to claim 3 whereby said Mn(VII) valent salt is potassium permanganate, KMnO₄.

9. The battery according to claim 3 whereby said Mn(VII) valent salt is NaMnO₄, LiMnO₄, RbMnO₄, CsMnO₄, ammonium permanganate, or a tetra alkyl ammonium permanganate.

10. The battery according to claim 2 whereby said compound contains a Mn(IV) valent salt.

11. The battery according to claim 10 whereby said Mn(IV) valent salt is manganese dioxide.

12. The battery according to claim 1 whereby said encapsulated powder is an encapsulated oxidized nickel containing compound.

13. The battery according to claim 12 whereby said compound contains a nickel oxide salt.

14. The battery according to claim 12 whereby said compound contains a nickel oxyhydroxide salt.

15. The battery according to claim 1 whereby said encapsulated powder is an encapsulated oxidized mercury containing compound.

16. The battery according to claim 1 whereby said encapsulated powder is an encapsulated oxidized lead containing compound.

17. The battery according to claim 1 whereby said encapsulated powder is an encapsulated oxidized copper containing compound.

18. The battery according to claim 1 whereby said encapsulated powder contains zero valent sulfur.

19. The battery according to claim 1 whereby said encapsulated powder contains a polysulfide including zero valent sulfur and reduced sulfur.

20. The battery according to claim 1 whereby said encapsulated powder is an encapsulated oxidized cobalt containing compound.

21. The battery according to claim 1 whereby said encapsulated powder is an encapsulated oxidized vanadium containing compound.

22. The battery according to claim 1 whereby said encapsulated powder is an encapsulated oxidized iron containing compound.

23. The battery according to claim 22 whereby said encapsulated powder contains a compound which includes iron in a valence state of greater than 3.

24. The battery according to claim 23 whereby said oxidized iron containing compound includes BaFeO₄.

25. The battery according to claim 23 whereby said oxidized iron containing compound includes K₂FeO₄.

26. The battery according to claim 23 whereby said oxidized iron containing compound includes Na₂FeO₄, Li₂FeO₄, Cs₂FeO₄, Rb₂FeO₄, H₂FeO₄, (NH₄)₂FeO₄, (N(C₄H₉)₄)₂FeO₄, BeFeO₄, MgFeO₄, CaFeO₄, SrFeO₄, La₂(FeO₄)₃, CeFeO₄.2H₂O, Ce₂(FeO₄)₃, Hg₂FeO₄, HgFeO₄, Cu₂FeO₄, CuFeO₄, ZnFeO₄, Ag₂FeO₄, FeO₃, FeFeO₄, Fe₂(FeO₄)₃, CrFeO₄, MnFeO₄, NiFeO₄, CoFeO₄, Al₂(FeO₄)₃, In₂(FeO₄)₃, Ga₂(FeO₄)₃, SnFeO₄, PbFeO₄, Sn(FeO₄)₂, or Pb(FeO₄)₂.

27. The battery according to claim 1 whereby said oxidized silver salt encapsulation of a powder is accomplished by a coating of metallic silver which is then oxidized.

28. The battery according to claim 1 whereby said oxidized silver salt encapsulation of a powder is accomplished with a solution containing a dissolved silver salt.

29. The battery according to claim 28 whereby said powder to be encapsulated is highly insoluble in said solution.

30. The battery according to claim 28 whereby said encapsulation is further accomplished by solvent evaporation from said solution.

31. The battery according to claim 28 whereby said encapsulation is further accomplished by salting out of said dissolved silver salt from said solution.

32. The battery according to claim 1 whereby said silver salt includes an Ag(I) valent salt.

33. The battery according to claim 32 whereby said Ag(I) valent salt includes Ag₂O or AgOH or includes an anion from the list nitrate, nitrite, halide, halate, perhalate, halite, acetate, carbonate, fulimate, lactate, acetylide, levunilate, oxalate, palimate, cyanate, thiocyanate, benzoate, propionate, salicyate, stearate, tartrate, tetraborate, sulfate, thiosulfate, dithionate, selenate, selinide, telluride, tungstate, azide, phosphate, orthophosphate or pyrophosphate.

34. The battery according to claim 1 whereby said silver salt includes an Ag(II) valent salt.

35. The battery according to claim 34 whereby said Ag(II) valent salt includes AgO, Ag₂O₂ or Ag(OH)₂ or includes an anion from the list nitrate, nitrite, halide, halate, perhalate, halite, acetate, carbonate, fulimate, lactate, acetylide, levunilate, oxalate, palimate, cyanate, thiocyanate, benzoate, propionate, salicyate, stearate, tartrate, tetraborate, sulfate, thiosulfate, dithionate, selenate, selinide, telluride, tungstate, azide, phosphate, orthophosphate or pyrophosphate.

36. The battery according to claim 30 whereby said Ag(I) salt is oxidized.

37. The battery according to claim 27 or 36 whereby said oxidation is accomplished through contact with an oxidizing agent.

38. The battery according to claim 37 whereby said oxidizing agent is a hypochlorite salt.

39. The battery according to claim 39 whereby said oxidizing agent is a peroxydisulfate salt.

40. The battery according to claim 27 or 36 whereby said oxidation is accomplished electrochemically by application of a positive voltage.

41. The battery according to claim 1, wherein said cell is rechargeable by application of a voltage in excess of the discharge cell open circuit potential.

42. A battery comprising two half-cells which are in an electrochemical contact with one another through an electrically neutral alkaline ionic conductor, wherein one of said half-cells comprises an anode and the other half-cell comprises a cathode, whereby electrical discharge is accomplished via reduction of the cathode and oxidation of the anode, and whereby said cathode includes at least 1% of weight of barium permanganate.
